(19) United States
(12) Patent Application Publication
(10) Pub. No.: US 2009/0193619 A1
(43) Pub. Date: Aug. 6, 2009

(54) Door hinge with a hidden closure system

(76) Inventor: Robert Irwin, Gainesville, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/012,690

(22) Filed: Feb. 4, 2008

(51) Int. Cl. E05D 11/02; E05D 5/10

(52) U.S. Cl. 16/274; 16/386

(57) ABSTRACT

A door hinge with a hidden closure system comprising, in general, a first hinge with a pin protruding from the face of the hinge, a second hinge with a hidden closure system, wherein such pin engages a latch and release mechanism and triggers a closure system in the second hinge during final approach, thus softly closing the door and reducing the sound of closure during the final approach of the door.

### RELATED APPLICATIONS

The present Nonprovisional Application is related to, and hereby claims priority to and the benefit of, U.S. Provisional Application No. 60/898,162, entitled “Door Hinge with a Hidden Closure System,” filed on Feb. 2, 2007.

### FIELD OF THE INVENTION

The present invention relates generally to door hinge and more specifically to a door hinge with a hidden closure system for soft closure of the door.

### BACKGROUND OF THE INVENTION

The conventional door hinge is composed of two leaves each engaging with the other by means of a pivot pin and sleeve. One leaf is fixed on the door edge and the other is fixed on the door frame. One or more hinges are used to pivot the door when opening or closing the door. For automatically closing the door with a conventional hinge, a hydraulic system, spring system or a combination system is typically affixed to the upper portion of door and to the horizontal beam of the upper door frame, thereby adding an industrial appearance to the door assembly. In addition, such door closing systems generally exerts a continuous resisting force requiring a big force to be applied to push the door open or hold the door in an open position, preventing the door from free swinging.

Moreover, such door closing systems apply a non-uniform force to the upper portion of the door disadvantageously resulting in a force offset from the rotational axis of the hinge assembly, thus deforming the door, hinge, latch/lock and frame over time. Furthermore, spring-based door closing systems frequently lose their resilient effect after lengthy period of service and will thereafter cause incomplete closing of the door. When a door is closed with the assistance of such door closing systems, it is typically forced to move in its closing direction rapidly, causing a noise to the ear and forceful impact, wherein the main elements of such a hinge, lock and door elements are impaired over time due to such force.

Furthermore, both hydraulic and spring door closing systems generally limit the radial travel of the door, to for example 90 degrees variation between close and open. Either a relatively high level of precision in manufacturing or size of hydraulics/spring is required in order to achieve radial travel to 180 degrees.

Therefore, it is readily apparent that there is a need for door hinge closure system for soft and quiet closure of a door during final approach, wherein such closure system is hidden within the door jam, frame or door, and wherein such closure system is non-continuous, thereby allowing the door to swing freely through the door hinges full range of motion and reduce the stress on the door, hinge, latch/lock and frame.

### BRIEF SUMMARY OF THE INVENTION

Briefly described, in a preferred embodiment, the present invention overcomes the above-mentioned disadvantage, and meets the recognized need for such an invention by providing a door hinge with a hidden closure system comprising, in general, a first hinge with a pin protruding from the face of the hinge, a second hinge with a hidden closure system, wherein such pin engages a latch and release mechanism triggering a closure system in the second hinge during final approach, and thus softly closing the door and reducing the sound of closure during the final approach of the door.

According to its major aspects and broadly stated, the present invention in its preferred form is a door hinge with a hidden closure system, comprising a first hinge with a pin protruding from the face of the hinge, a second hinge with a latch and release mechanism, and a closure system housed in a cylindrically shaped body hidden behind such second hinge, wherein the pin from the first hinge engages the latch and release mechanism and triggers a closure system in the second hinge during final approach enabling a free swinging door prior to such engagement, and further wherein latch engagement activates a closure cycle of the closure system pulling the door closed.

More specifically, the preferred embodiment of the present invention further comprises a locking mechanism for holding the closing system in a compressed potential energy position, wherein release thereof pulls the latched door closed softly.

Accordingly, a feature and advantage of the present invention is its ability to provide a door hinge with a non-continuously latched closure system, thus allowing the door to swing freely when the mechanism is released.

Another feature and advantage of the present invention is its ability to provide a door hinge wherein the closure system is hidden within the door jam, door frame or within the door, rendering an enhanced aesthetic appearance.

Still another feature and advantage of the present invention is its ability to provide a closure cylinder utilizing hydraulic oil, nitric oxide, air or other compressible material.

Yet another feature and advantage of the present invention is its ability to provide a door hinge that softly closes the door reducing the sound of closure during the final approach of the door.

Yet another feature and advantage of the present invention is its ability to provide a door hinge with a soft closure system that prevents a door from rapid opening or closing so as to protect the door, doorframe, or surroundings from being damaged.

Yet another feature and advantage of the present invention is its ability to provide a door hinge with a soft closure system that cushions door closure, thereby reducing the stress on the door, hinge, latch/lock and frame.

Yet another feature and advantage of the present invention is its ability to provide a door hinge that unlatches from a closing system and swings freely throughout the door hinges full range of motion.

Yet another feature and advantage of the present invention is its ability to provide a simple, compact, and inexpensive door hinge with a latch and release mechanism and closure system.

Yet another feature and advantage of the present invention is its ability to provide a door closer, which can smoothly and effectively close the door after opening and releasing.

Yet another feature and advantage of the present invention is its ability to engage a latch and release mechanism during the door's final approach.

Yet another feature and advantage of the present invention is its ability to reduce the opening force required to open the door facilitating accessibility for small children, elderly, handicapped and those with disabilities.

Yet another feature and advantage of the present invention is its ability to provide a door hinge that can motion the door to a closed position in a smooth and slow manner during final approach.

Yet another feature and advantage of the present invention is its ability to provide a door hinge assembly that can be sold as a replacement hinge assembly for retrofitting existing door hinges.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a front view of a prior art dual door assembly showing three hinges spaced vertically between a door frame and a swinging door, showing the hinges in a closed state;

FIG. 1.1 is an enlarged perspective view showing a prior art whole body of a door hinge shown in FIG. 1 in the open state;

FIG. 2 is a front view of a prior art dual door with two enlarged perspective views of a door hinge in the open state according to a preferred embodiment of the present invention;

FIG. 2.1 is an enlarged perspective view showing a whole body of a door hinge shown in FIG. 2 in the open state according to a preferred embodiment of the present invention;

FIG. 2.2 is perspective view of the latch hook and mounting tube according to the preferred embodiment of the present invention;

FIGS. 3, 3.1, 3.2, and 3.3 are cross-sectional front views of the latch and release mechanism, and closure system according to the preferred embodiment of the present invention, shown in operation with the latch disengaged;

FIGS. 4, 4.1, 4.2, and 4.3 are cross-sectional front views of the latch and release mechanism, and closure system according to an alternate embodiment of the present invention, shown in operation with the latch approaching engagement;

FIGS. 5, 5.1, 5.2, and 5.3 are cross-sectional front views of the latch and release mechanism, and closure system according to the preferred embodiment of the present invention, shown in operation with the latch engaged;

FIGS. 6, 6.1, 6.2 and 6.3 are cross-sectional front views of the latch and release mechanism, and closure system according to the preferred embodiment of the present invention, shown in operation with locking mechanism about to release;

FIG. 7, 7.1 are cross-sectional front views of the latch and release mechanism, and closure system according to the preferred embodiment of the present invention, shown in operation with closure mechanism;

FIG. 10 is a perspective view of a door hinge in the open state with mounting tube and unassembled accessories according to a preferred embodiment of the present invention; and

FIG. 11 is a perspective view of a door hinge in the open state with mounting tube shown assembled according to a preferred embodiment of the present invention.

### DETAILED DESCRIPTION OF THE INVENTION

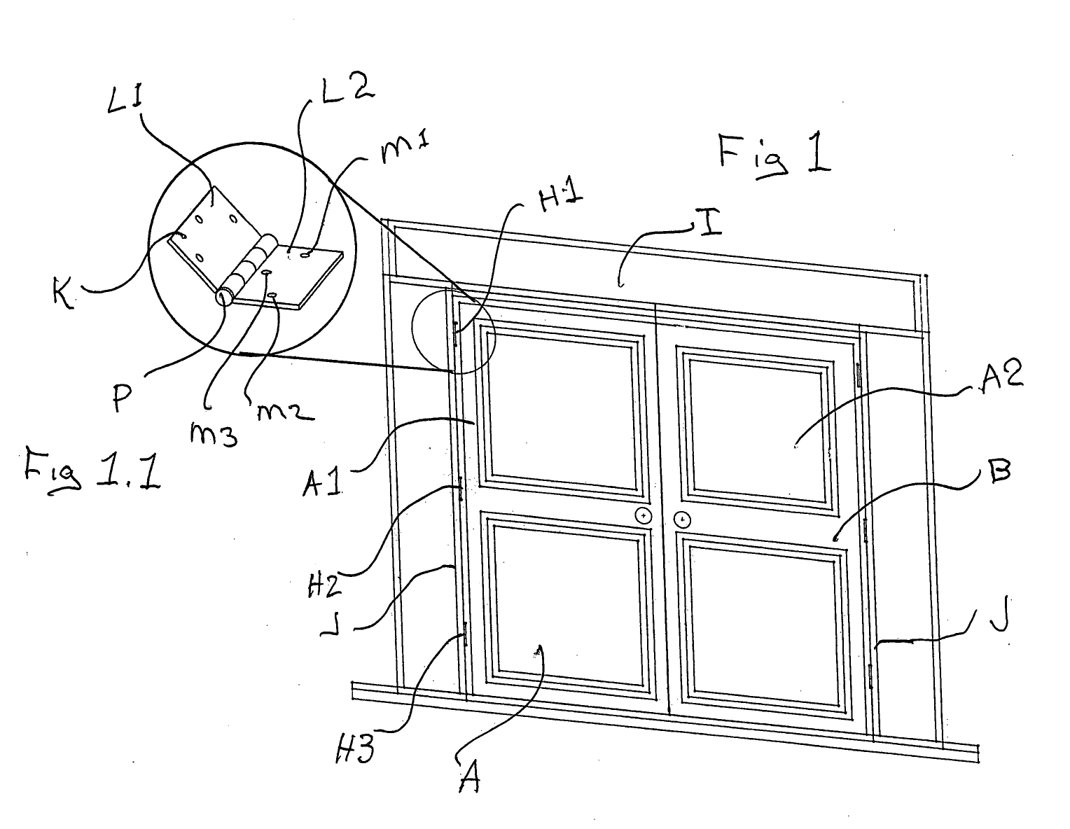

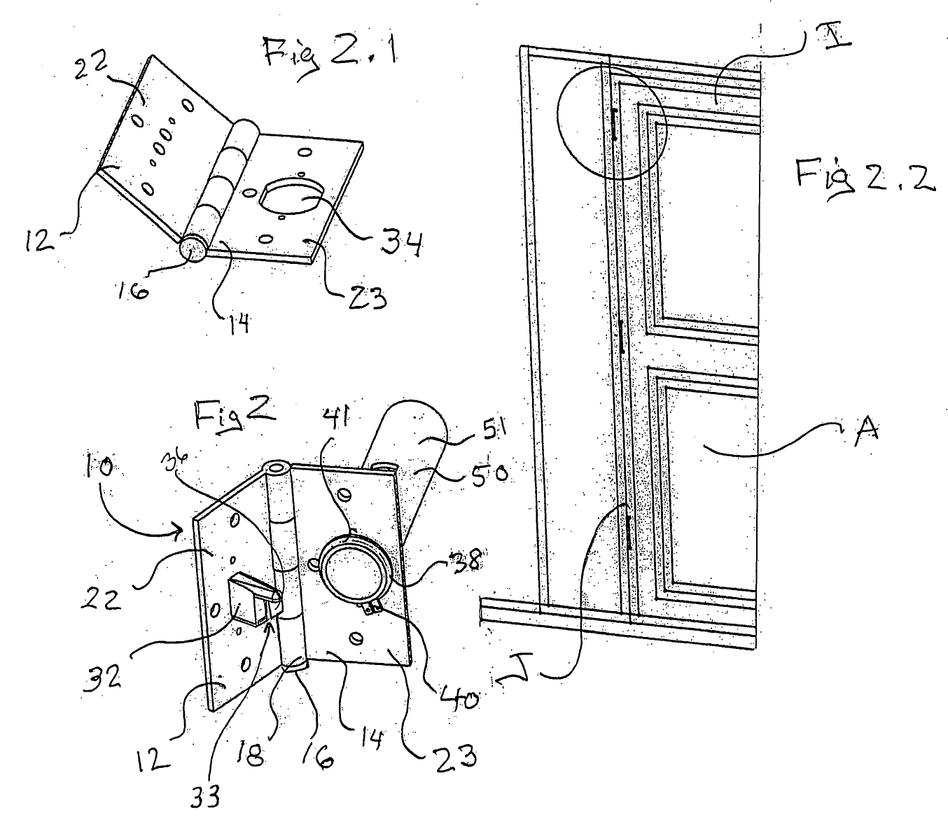

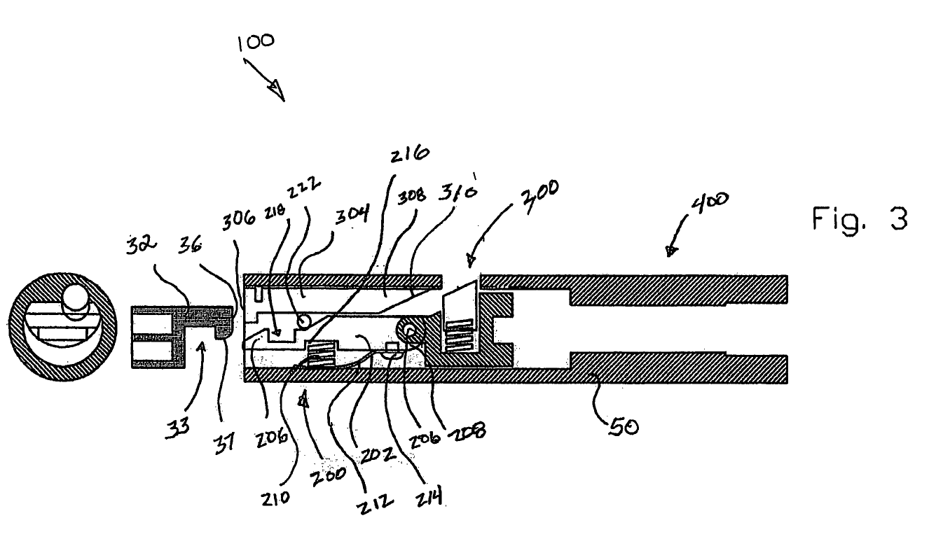

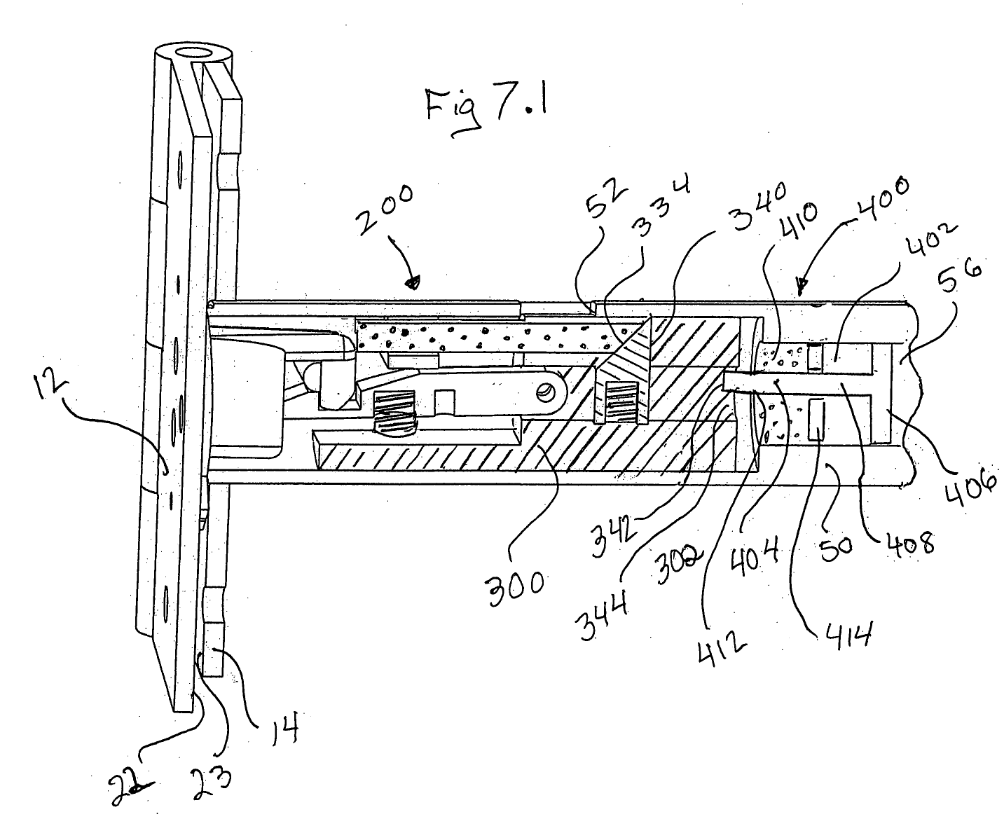

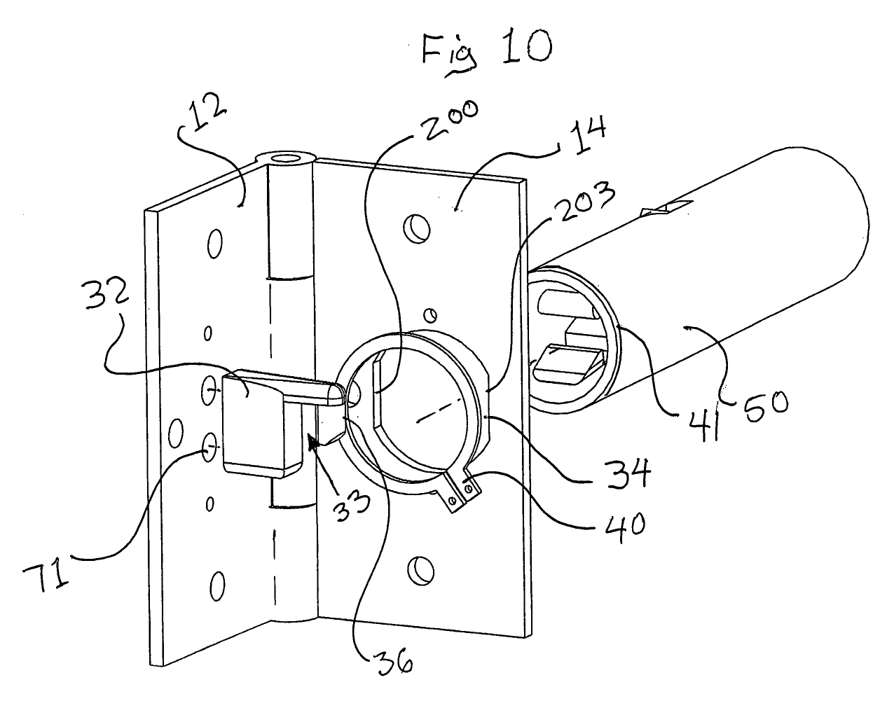

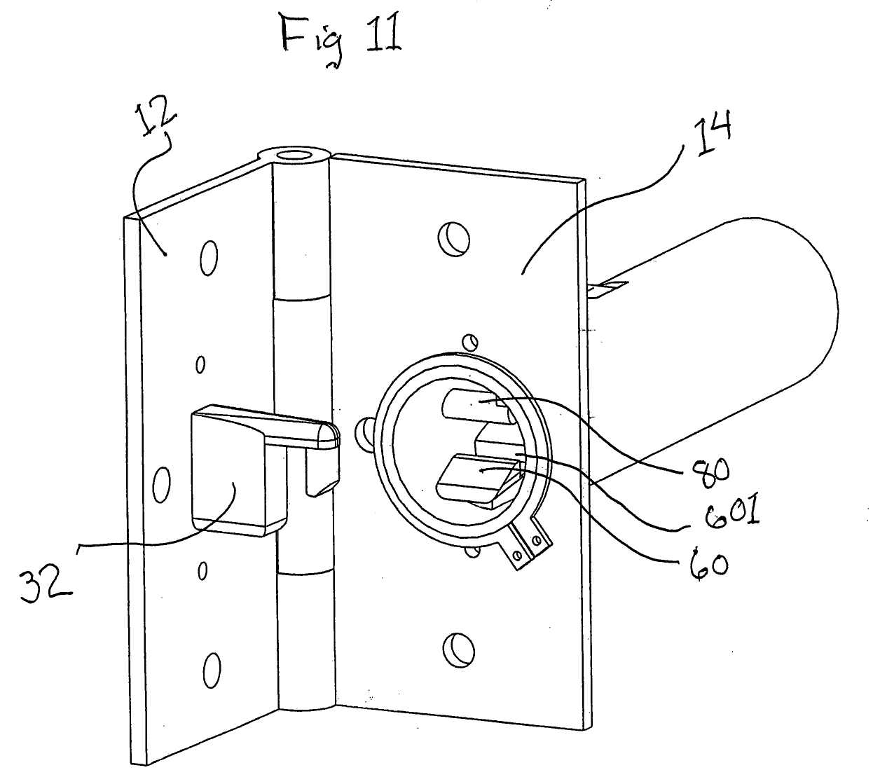

In describing the preferred and alternate embodiments of the present invention, as illustrated in FIGS. 1-7, 10 and 11 specific terminology is employed for the sake of clarity. The present invention, however, is not intended to be limited to the specific terminology so selected, and it is to be understood that each specific element includes all technical equivalents that operate in a similar manner to accomplish similar functions.

Referring now to FIGS. 1 and 1.1, there is depicted a prior art door A and door B shown in a side-by-side configuration, door jam J, door header I and a three hinge assembly H1, H2, and H3. The door A, which may swing inward, toward the viewer as depicted in FIG. 1, fits closely to the jam J at both its hinge edge A1 and its opposite or latch edge A2. Door B is positioned in a similar manner. Such door A and door B may be configured to swing inward or outward by switching the configuration of hinge assembly H1, H2, and H3. It should be noted, also, that no hinge is exposed to view along the hinge edge A1 when the door is closed as viewed from the other side of door A and door B.

As illustrated in FIG. 1.1, by way of example, and not limitation, there is illustrated a perspective view of a typical prior art hinge assembly H1 having two hinge leaves formed as a pair, a stationary hinge leaf L1 and a rotatable hinge leaf L2, and connected therebetween a hinge pin P. The hinge leaves (L1, L2) have offset knuckles K which when interlinked may be joined together by the hinge pin P. Each hinge leaf is shown with three mounting holes M1, M2, and M3 formed in the hinge leaves. The stationary hinge leaf L1 is secured to door jam J utilizing a flathead screw, nail or the like driven through mounting holes M of such stationary hinge leaf L1, while the rotatable hinge leaf L2 is secured to opening-and-closing door A or B, or the like, also utilizing a flat screw, nail or the like driven through mounting holes M of such rotatable hinge leaf L2. To hang door A or B to door jam J, door A or B is positioned near door jam J so that knuckles K of stationary hinge leaf L1 are interlinked with knuckles K of rotatable hinge leaf L2 and pin P is inserted into such interlinked knuckles of stationary hinge leaf L1 and rotatable hinge leaf L2, thereby enabling door A or B to freely rotationally swing about pin P with stationary hinge leaf L1 affixed to door jam J.

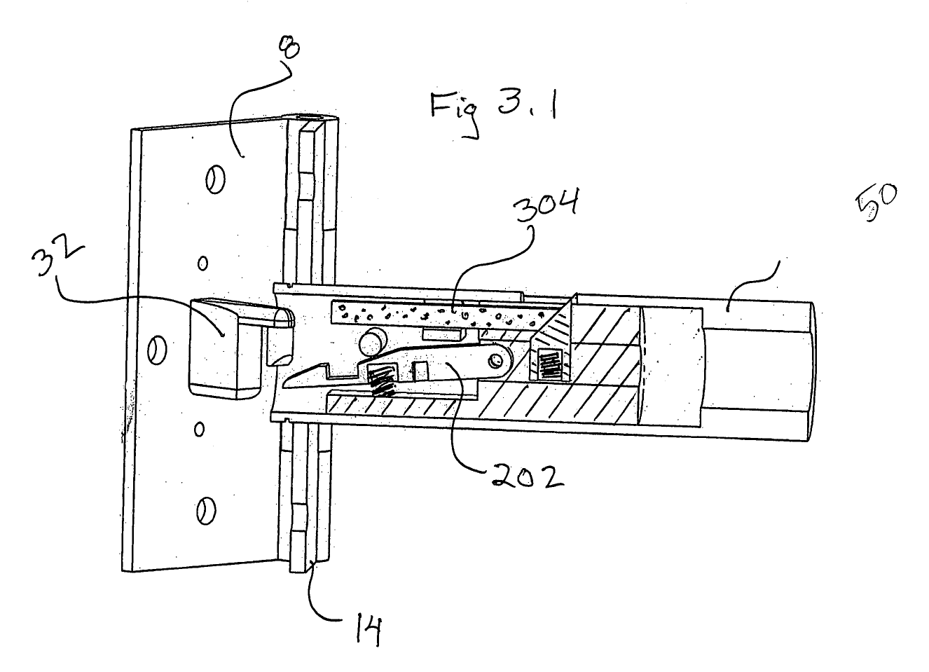

Referring now to FIG. 2, stationary hinge leaf L1, rotatable hinge leaf L2, knuckles K, and hinge pin P are preferably formed of a suitable material, such as brass, iron, steel, or other metals, plastic, including various finishes from chrome, antiqued copper, black, and brass (either plated or pure brass) or the like, capable of providing structure and strength to hinge assembly H1. Preferably, the material includes other suitable characteristics, such as durability, water-resistance, light weight, malleable, oxidation resistance, ease of workability, or other beneficial characteristic understood by one skilled in the art. Moreover, hinge assembly H1 may come in an endless variety of types, shapes, sizes and purposes, including but not limited to butt hinges, strap hinge, spring hinge, wide throw hinge, left hand, right hand hinge and the like.

Referring now to FIGS. 2.1 and 2.2, the present invention in its preferred embodiment is a door hinge with a hidden closure system 10. Preferably, door hinge with a hidden closure system 10 comprises two hinge leaves formed as a pair, a stationary hinge leaf 12 and a rotatable hinge leaf 14, and connected therebetween by a hinge pin 16. The hinge leaves (12, 14) preferably have offset knuckles 18 which, when interlinked, may be joined together by hinge pin 16. Each hinge leaf has front face 22 shown toward the viewer as depicted in FIG. 2 and back face 24 (not shown).

Stationary hinge leaf 12 preferably includes latch hook 32 integrally provided with front face 22 preferably centered on stationary hinge leaf 12 and preferably projecting perpendicular to front face 22 of stationary hinge leaf 12. Alternatively, latch hook 32 may be mounted to stationary hinge leaf 12 by machining one or more holes in stationary hinge leaf 12 and affixing latch hook 32 to stationary hinge leaf 12 with screws from back face 24 side of stationary hinge leaf 12. Further, other basic hinge designs may also be adapted or manufactured with hidden closure systems 10, wherein exemplary preferred hinge as depicted in FIG. 2.1 is but a suitable base hinge style.

Rotatable hinge leaf 14 preferably includes locator hole 34 preferably centered on front face 22 of rotatable hinge leaf 14 but in a location designed to align with the position of latch hook 32 when in use. Further, rotatable hinge leaf 14 is integrally provided with mounting tube 50 connected through locator hole 34 in a circular cylindrical form centered on rotatable hinge leaf 14 and projecting perpendicular from back face 24 of rotatable hinge leaf 14. Locator hole 34 preferably is one inch in diameter, wherein such diameter hole is correspondingly drilled or otherwise defined into door A or B to the preferred depth of 3.5 to 4.5 inches, or alternatively into door jam J if rotatable hinge leaf 14 and stationary hinge leaf 12 flip positions. Dimensions of locator hole 34 and the depth are determined based on the size and shape of mounting tube 50 and rotatable hinge leaf 14. That is, the dimensions referenced as preferred herein above are understood as one preferred configuration herein, and are not intended to be dimensions which are limiting in any way to other suitable configurations.

Mounting tube 50 preferably includes rim 38 and circumference groove 41, preferably formed on the outer surface 51 at open end 34 of mounting tube 50, wherein groove 41 preferably is provided in the end portion mounting tube 50 to captively receive and retain inserted snap ring 40. During use, mounting tube 50 preferably is inserted into locator hole 34 and into the cylindrical bore of door A or B or the like. With inserted snap ring 40 in its retention/locking position as shown in FIG. 2.1, mounting tube 50 preferably is affixed to rotatable hinge leaf 14 and resiliently resists separation from rotatable hinge leaf 14. Mounting tube 50 is further preferably manufactured from aluminum, however, steel, plastic, fiberglass or other suitable material having characteristics, such as durability, water-resistance, lightweight, or other beneficial characteristic understood by one skilled in the art.

Although the foregoing describes the preferred dimensions and materials selections for the manufacture of stationary hinge leaf 12, rotatable hinge leaf 14, latch hook 32, and mounting tube 50, it should be recognized that stationary hinge leaf 12, rotatable hinge leaf 14, latch hook 32, and mounting tube 50 and its inner workings may comprise alternate dimensions and/or materials to accommodate the door hinge with a hidden closure system 10.

Door Hinge Close Cycle

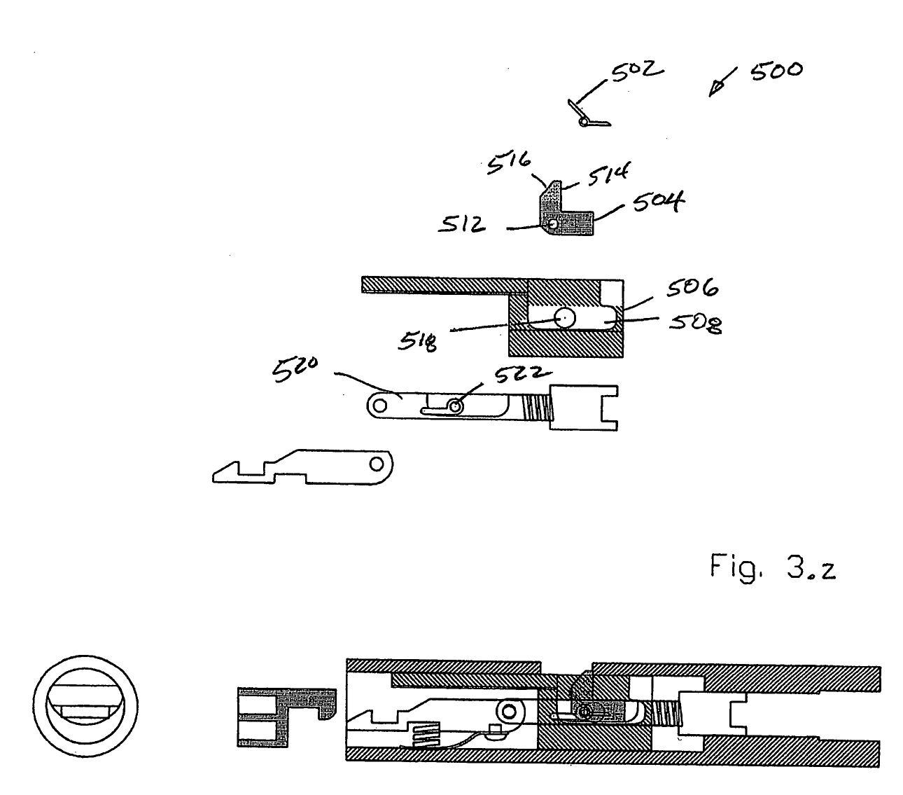

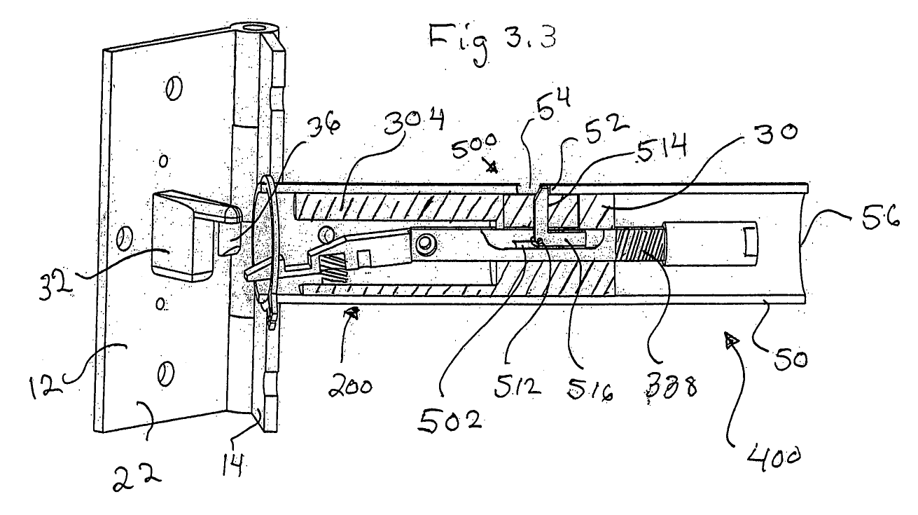

Referring now to FIGS. 3/3.1-7/7.1, by way of example, and not limitation, there is illustrated a cross-sectional view of latch and release mechanism and closure system 100, showing a cross section of mounting tube as if in an installed position and proximate rotatable hinge leaf 14 and showing latch hook 32 as if in an installed position extending from stationary hinge leaf 12. In use, door A or B preferably is swung shut and front face 23 of rotatable hinge leaf 14 approaches front face 22 of stationary hinge leaf 12 until, at about twenty-six (26) degrees (other degrees are contemplated herein) from front face 23, contacting front face 22. Upon contact, latch hook 32 preferably penetrates locator hole 34 of mounting tube 50 and rotatable hinge leaf 14, and contacts both magnetic rod 304 of locking mechanism 300 and latch plate 102 of latch and release mechanism 200 as housed within such mounting tube 50, as shown in FIGS. 3, 3.1, 3.2, and 3.3. Bull nose 36 of latch hook 32 preferably contacts first end 306 of magnetic rod 304, arranged for sliding in a horizontal direction, wherein bull nose 36 pushes said magnetic rod 304 in a direction towards closed end of mounting tube 50. In addition, tip 37 of latch hook 32 preferably contacts slanted first end 206 of latch plate 202, thereby rotating latch plate 202 in a counter clockwise arc about radial pin 206, wherein second end 208 of latch plate 202 is attached thereto. Radial pin 206 preferably is affixed to first end 302 of locking mechanism 300.

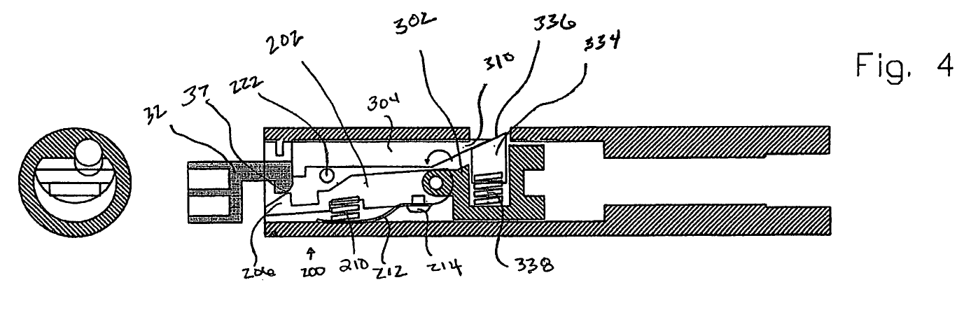

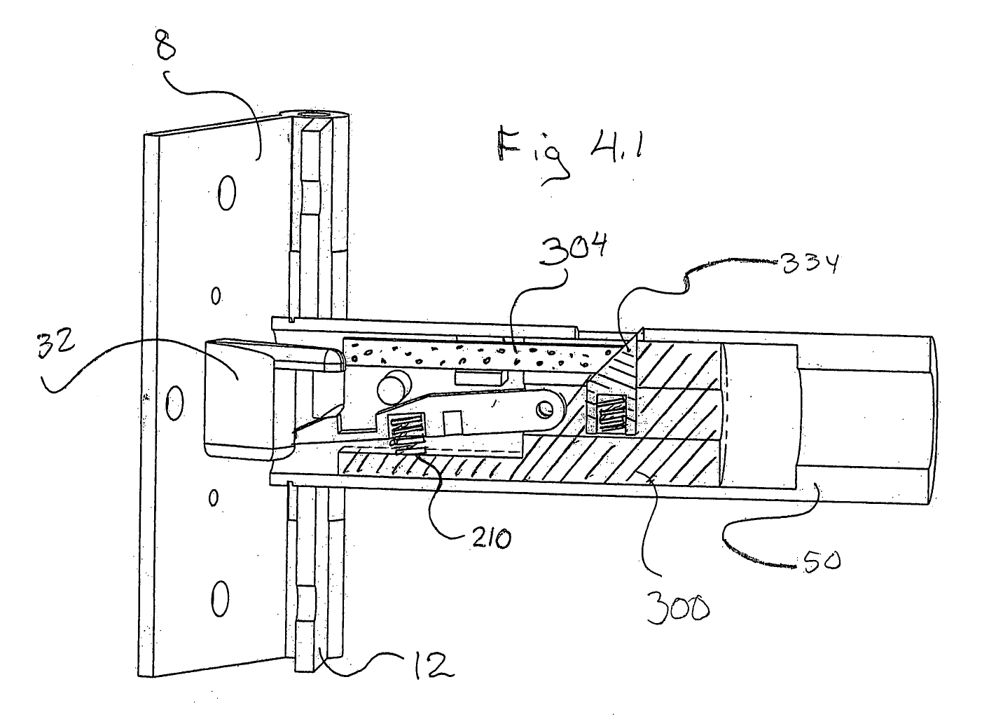

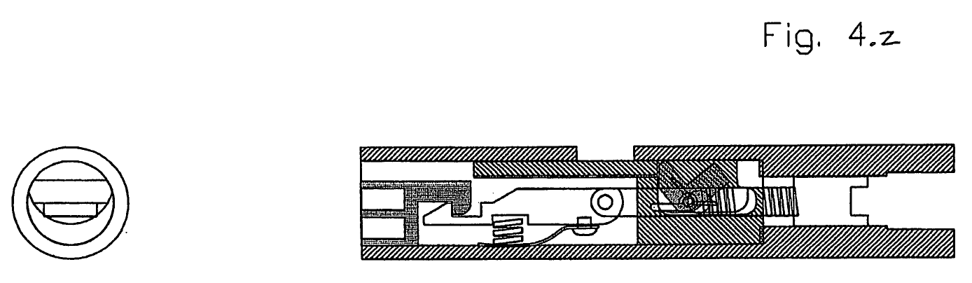

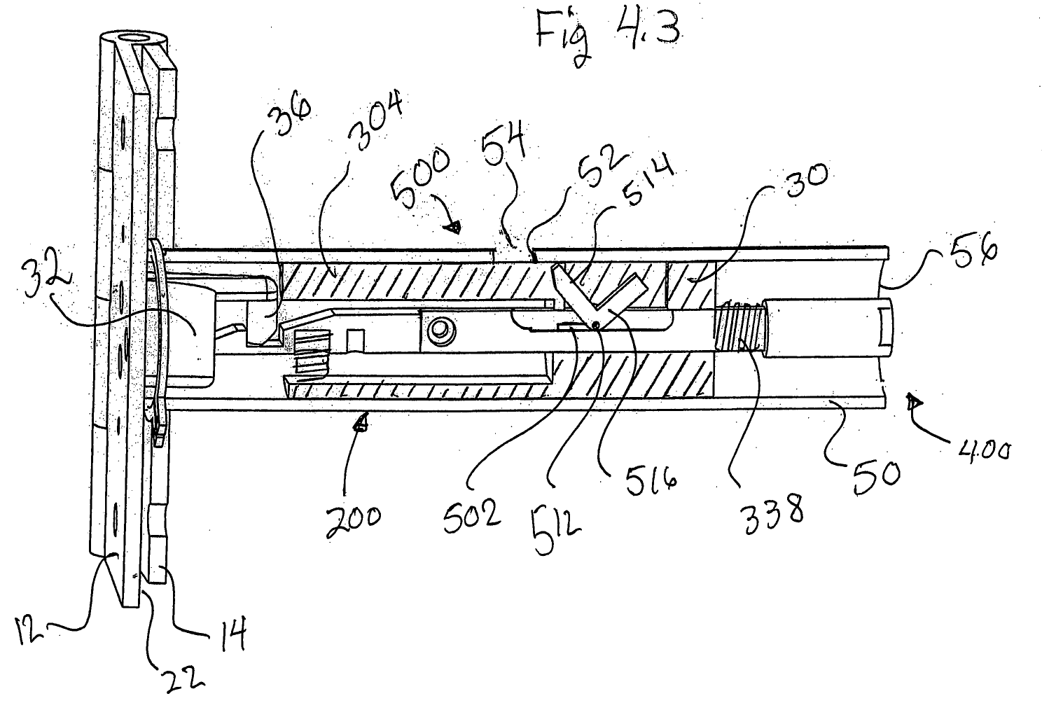

Referring now to FIGS. 4, 4.1, 4.2, and 4.3, tip 37 of latch hook 32 preferably forces first slanted end 206 of latch plate 202 down, compressing latch plate spring 210, and enabling latch hook 32 to slide in a horizontal direction over first slanted end 206 of latch plate 202. Latch plate spring 210 preferably is positioned and secured to the underside of latch plate 202 by radial arm 212 and screw 214 preferably in first notch 216 of latch plate 202. Moreover, latch plate spring 210 preferably holds latch plate 202 against stop 222 until latch hook 32 contacts latch and release mechanism 200.

As door A or B is further pulled closed, front face 23 of rotatable hinge leaf 14 continues to approach front face 22 of stationary hinge leaf 12 and bull nose 36 of latch hook 32, as affixed to front face 22 of stationary hinge leaf 12, preferably continues to push magnetic rod 304 in a horizontal direction towards closed end 56 of mounting tube 50. During such horizontal travel of magnetic rod 304, second slanted end 310 of magnetic rod 304 preferably contacts first slanted end 336 of spring post 334 and preferably pushes spring post 334 down in a vertical direction compressing spring post spring 338.

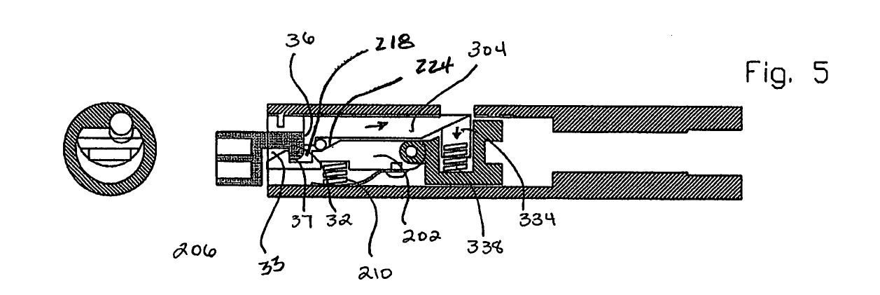

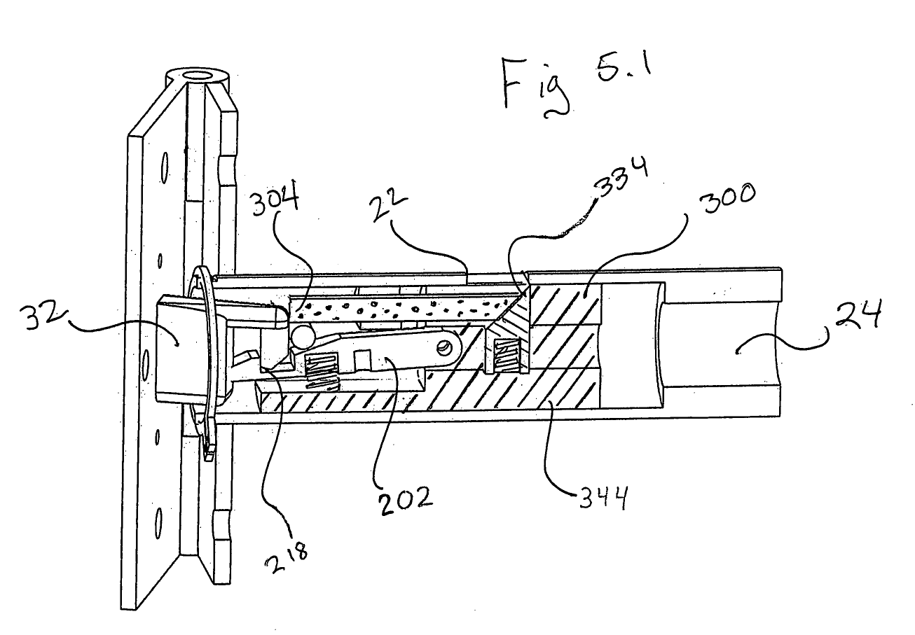

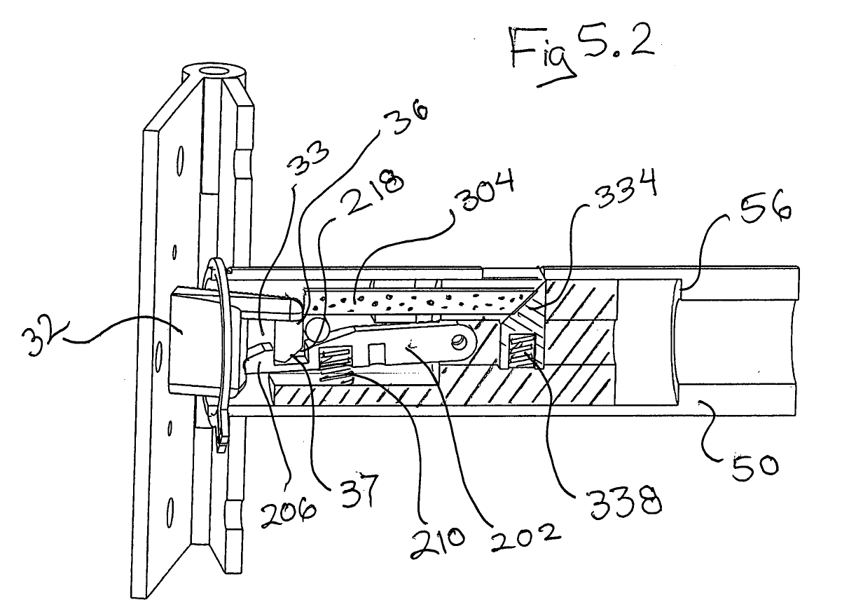

Referring now to FIGS. 5, 5.1, 5.2, and 5.3 as door A or B is still further pulled, closed tip 37 of latch hook 32 preferably passes over first slanted end 206 of latch plate 202 and tip 37 of latch hook 32 latches into latch plate notch 218, wherein latch plate spring 210 releases from its compressed, position pushing latch plate 202 up in a vertical direction and latching first slanted end 206 of latch plate 202 into notch 33 of latch hook 32. Moreover, as door A or B is still further pulled closed, bull nose 36 of latch hook 32 preferably continues to push magnetic rod 304 further in a horizontal direction towards closed end 56 of mounting tube 50, resulting preferably in further descent of spring post 334, still further down in a vertical direction while further compressing spring post spring 338.

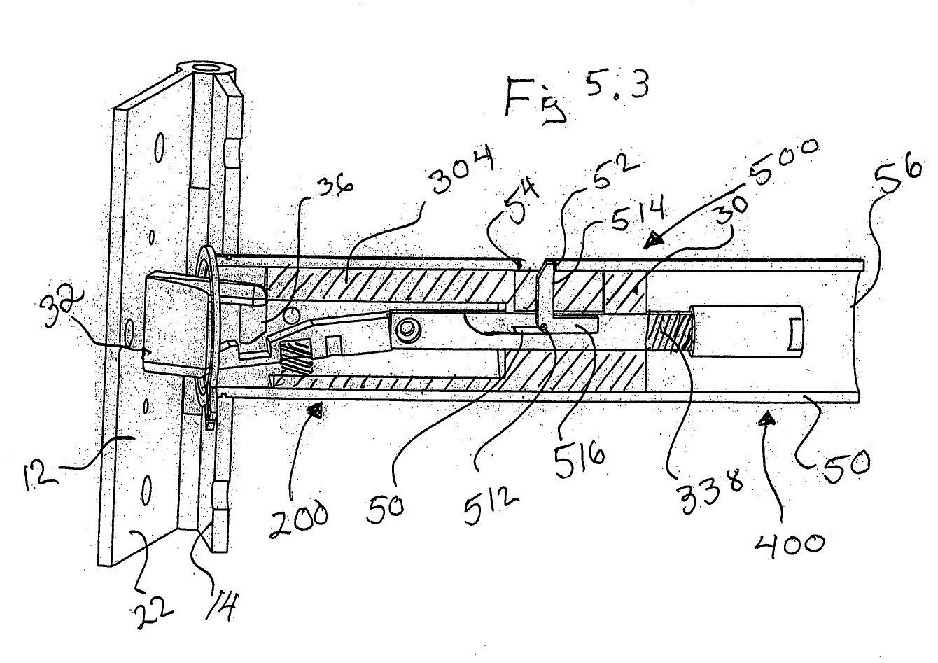

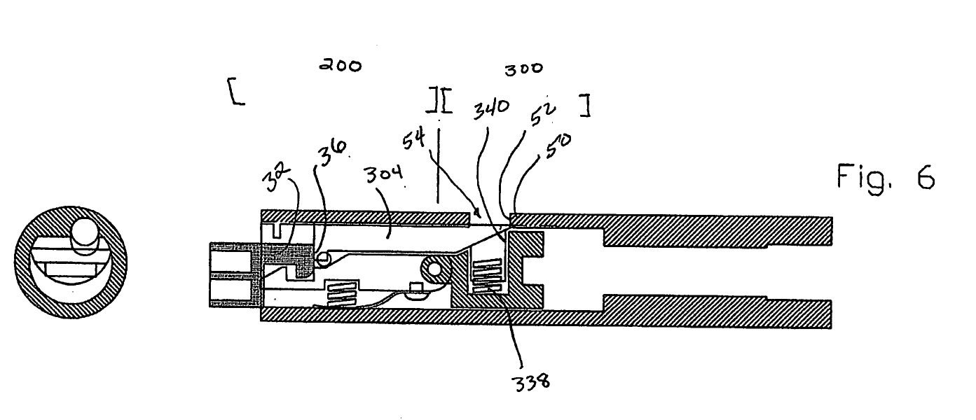

Referring now to FIGS. 6, and 6.1, and as door A or B is yet still further pulled closed, bull nose 36 of latch hook 32 preferably continues to push magnetic rod 304 further in a horizontal direction towards closed end 54 of mounting tube 50, resulting in leading edge 340 of spring post 334, which comprises generally a vertical surface 346 as a stopper for locking mechanism 300, to still further descend down in a vertical direction while further compressing spring post spring 338. Upon leading edge 340 of spring post 334 descending past surface 52 of notch 54 in mounting tube 50, locking mechanism 300 is released. Such release of locking mechanism 300 enables the collective travel of latch hook 32 affixed to latch and release mechanism 200, and locking mechanism 300 affixed to latch and release mechanism 200 to travel as a single linear unit in a horizontal direction towards closed end of mounting tube 50.

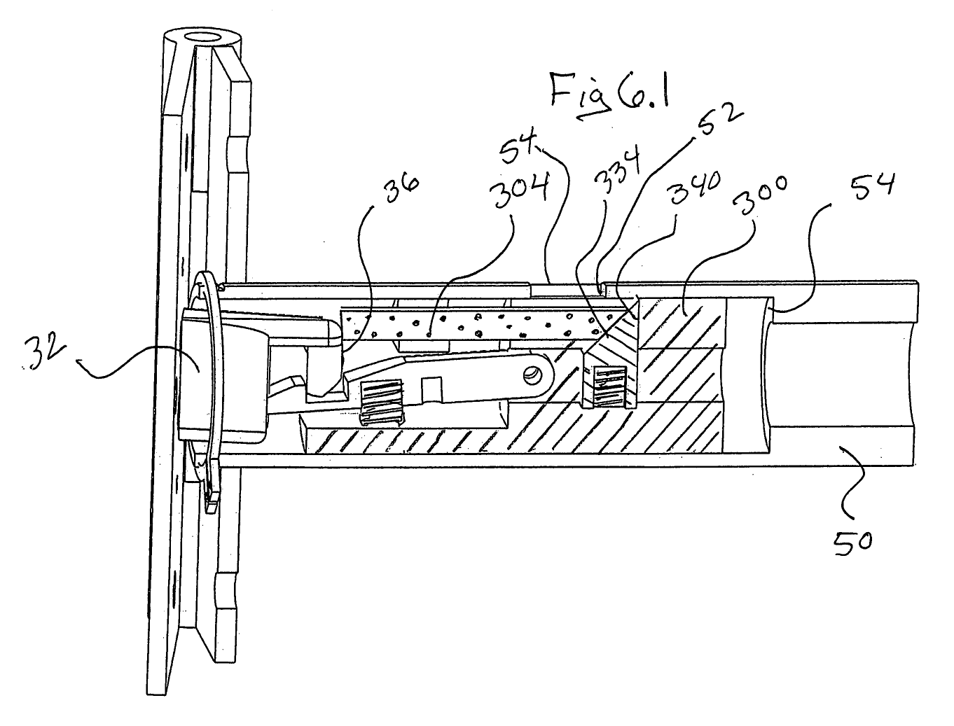

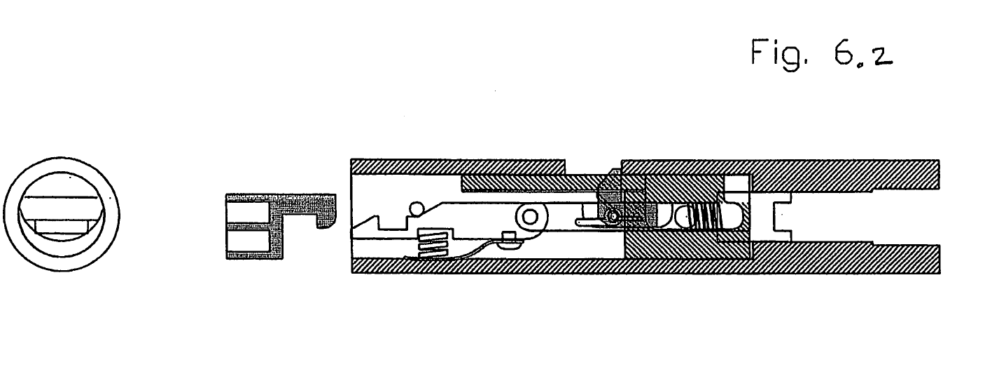

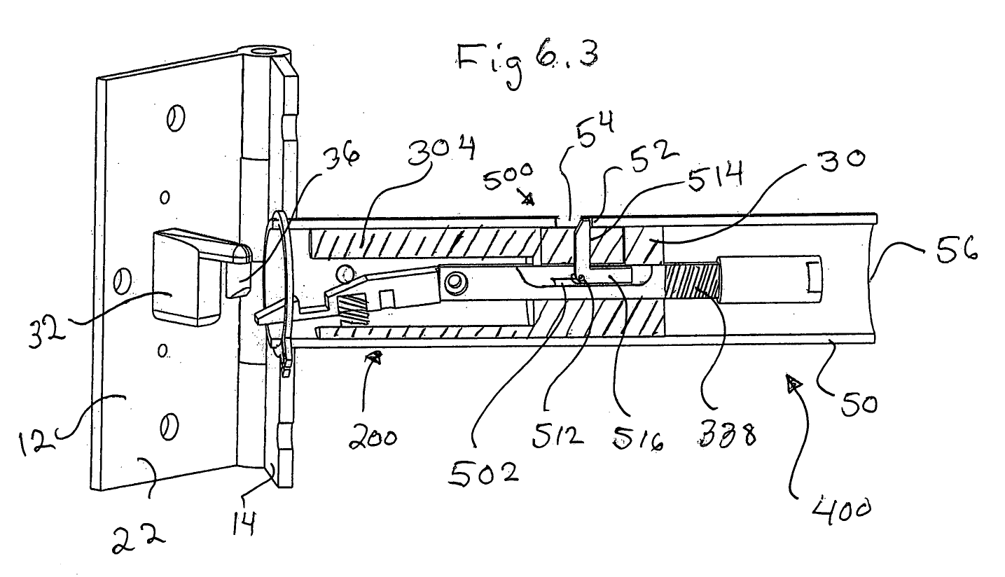

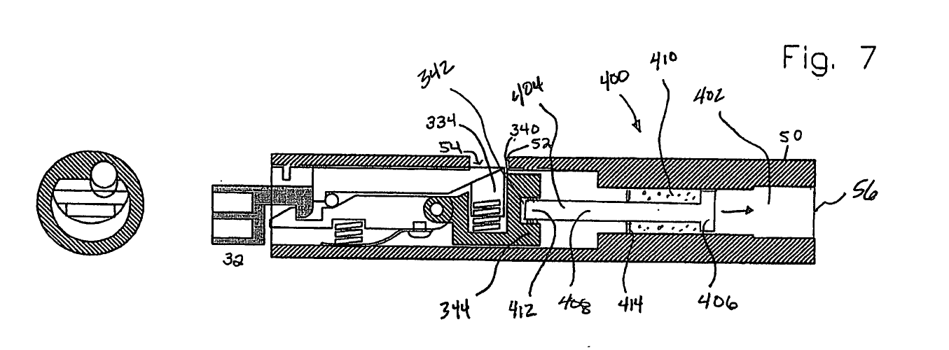

Referring now to FIGS. 7 and 7.1, and upon leading edge 340 of spring post 334 clearing surface 52 of notch 54 in mounting tube 50, closure mechanism 400 is released, thereby pulling latch hook 32, as affixed to latch and release mechanism 200. Locking mechanism 300, as affixed to latch and release mechanism 200 thus travels as a single unit in a linear horizontal direction towards closed end 56 of mounting tube 50 resulting in front face 23 of rotatable hinge leaf 14 coming into contact with front face 22 of stationary hinge leaf 12, as shown in FIG. 2.1, and further resulting in door A or B preferably closing softly under the control of closure mechanism 400.

Preferably, closure mechanism 400 includes cylinder 402 and piston 404. Cylinder 402 preferably is configured to fit inside mounting tube 50 as shown and further designed to contain a compressed fluid or gas 410, wherein such cylinder 402 contains such fluid or gas while in a compressed or uncompressed state. Piston 404 preferably includes rod 408 with compression disc 406 at a first end 404 of rod 408 and a threaded end 412 at a second end 406 of rod 408. Threaded end 412 of rod 408 preferably is screwed into machined notch 342 of second end 344 of locking mechanism 300. It is contemplated herein that other means for affixing end 412 of rod 408 to notch 342 of second end 344 of locking mechanism 300, such as adhesive, welding, eye joint, ball joint and the like. During door A or B open cycle (closure mechanism 400 compression cycle), rod 408 with compression disc 406 moves in a linear horizontal direction, such force provided by an operator of door A or B, toward latch hook 32 compressing such fluid or gas 410 within the reduced volume between seal 414 of cylinder 402 and compression disc 406. During door A or B closure cycle (closure mechanism 400 expansion cycle), rod 408 with compression disc 406 moves in a linear horizontal direction, such force provided by the expansion force of fluid or gas 410 under pressure, toward closed end 56 of mounting tube 50.

Closure mechanism 400 preferably is designed by one having ordinary skill in the art to provide the pulling force necessary to softly close door A or B. Industrial Gas Springs, Inc. of West Chester, Pa. and Stabilus of Gastonia, N.C. manufacture suitable micro compression gas springs suitable for closure mechanism 400 and the like.

Door Hinge Open Cycle

Referring now to FIGS. 3/3.1-7/7.1 in reverse, by way of example, and not limitation, there is illustrated a cross-sectional view of latch and release mechanism and closure system 100. As door A or B is pulled open, latch hook 32, as affixed to latch and release mechanism 200, and locking mechanism 300, also as affixed to latch and release mechanism 200, travel as a single unit in a linear horizontal direction towards latch hook 32, resulting in front face 23 of rotatable hinge leaf 14 separating from and swinging away from front face 22 of stationary hinge leaf 12 and further resulting in door A or B preferably opening softly under the control of closure mechanism 400. During door A or B open cycle (closure mechanism 400 compression cycle), rod 408, (via magnetic attraction and the force of spring post spring 338), with compression disc 406 moves, spring post spring 338, in a linear horizontal direction, wherein force directed by an operator of door A or B toward latch hook 32 compresses such fluid or gas 410 within the reduced volume between seal 414 of cylinder 402 and compression disc 406. Upon leading edge 340 of spring post 334 of locking mechanism 300 clearing surface 52 of notch 54 in mounting tube 50, closure mechanism 400 has fully compressed fluid or gas 410. As door A or B is further pulled open, latch hook 32 preferably continues to pull magnetic rod 304 further in a horizontal direction towards latch hook 32, thereby resulting in spring post spring 338 being released from its compressed position and leading edge 340 of spring post 334 coming into contact with surface 52 of notch 54 in mounting tube 50 of locking mechanism 300, which comprises generally a vertical surface as a stopper for locking mechanism 300 to maintain closure mechanism 400 when in a compressed potential energy position.

As door A or B is still further pulled open, the unit continues to travel in a linear horizontal direction towards latch hook 32, resulting in second slanted end 224 of latch plate 202 contacting stop 222, wherein stop 222 forces latch plate 202 down compressing latch plate spring 210, thus, enabling latch hook 32 to disengage latch plate 202. Latch plate spring 210 preferably is released from its compressed position and pushes latch plate 202 against stop 222. Preferably, latch plate 202 and magnetic rod 304 have now returned to their starting positions.

Upon latch hook 32 disengaging latch plate 202, front face 23 of rotatable hinge leaf 14 continues to separate and swing away from front face 22 of stationary hinge leaf 12, resulting in door A or B preferably swinging freely through rotatable hinge leaf 14 and stationary hinge leaf 12 full range of motion.

It should be recognized that door hinge with a hidden closure system 10, according to any one or more of the various preferred and/or alternate embodiments described herein, may be utilized to engage a latch and release mechanism and closure system to latch and close softly and unlatch from the closing system and swings freely throughout the door hinges full range of motion.

It is contemplated in an alternate embodiment that door hinge with a hidden closure system 10 could be manufactured using different materials and designs accomplishing the same function as latch hook 32, release mechanism 200, locking mechanism 300, and closure mechanism 400. Referring now to FIG. 3.2/3.3-7.2/7.3, by way of example, and not limitation, there is illustrated a cross-sectional view of an alternate locking mechanism 500. As illustrated in FIG. 3.2/3.3-7.2/7.3 similar elements and element nomenclature as set forth in FIGS. 3/3.1-7/7.1 is used throughout.

Door Hinge Close cycle

Referring now to FIGS. 3.2/3.3 and 6.2/6.3, as door A or B is yet still further pulled closed, bull nose 36 of latch hook 32 preferably continues to push roller release rod 304 further in a horizontal direction towards closed end of mounting tube 50, momentarily compressing compression spring 338 resulting in surface 514 of l-shaped locking paw 516 being momentarily moved away from corresponding surface 52 of notch 54 in mounting tube 50 (and resting pad 30 in FIG. 4.3), thereby enabling locking paw 516 to rotate around pin 512 in a counter clockwise direction. Locking paw 516 and surface 52 of notch 54 in mounting tube 50 comprise a stopper for locking mechanism 500. Once surface 514 of 1-shaped locking paw 516 is released from corresponding surface 52 of notch 54 in mounting tube 50, locking paw 516 rotates around pin 512 via torsion spring 502. Upon surface 514 of 1-shaped locking paw 516 being momentarily moved away from corresponding surface 52 of notch 54 in mounting tube 50 (and resting pad 30 in FIG. 4.3) locking paw 516 releases locking mechanism 500. Such release of locking mechanism 500 enables the collective travel of latch hook 32 as affixed to latch and release mechanism 200, and locking mechanism 500, also as affixed to latch and release mechanism 200 to travel as a single linear unit in a horizontal direction towards closed end 56 of mounting tube 50. Closure mechanism 400 preferably provides the pulling force necessary to softly close door A or B.

Door Hinge Open Cycle

As door A or B is pulled open latch hook 32 as affixed to latch and release mechanism 200, and locking mechanism 300, also as affixed to latch and release mechanism 200 travel as a single unit in a linear horizontal direction towards latch hook 32 resulting in front face 23 of rotatable hinge leaf 14 separating from and swinging away from front face 22 of stationary hinge leaf 12, and further resulting in door A or B preferably opening softly under the control of closure mechanism 400. During the return travel, roller release rod 304 contacts the backside of surface 514 of locking paw 516 causing locking paw 516 to rotate around pin 512 in a clockwise direction, thereby tensioning torsion spring 502 and resetting surface 514 of 1-shaped locking paw 516 against corresponding surface 52 of notch 54 in mounting tube 50 (and resting pad 30 in FIG. 4.3), which comprises generally a stopper for locking mechanism 500 to maintain closure mechanism 400 in a compressed potential energy position.

Having thus described the preferred and selected alternate embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A door hinge, comprising:
a hinge pin;
a stationary hinge leaf fixed to said hinge pin and adapted to be fixed to the door frame;
a rotatable hinge leaf rotatably mounted to said hinge pin and adapted to be fixed to the door;
a latch hook affixed to said stationary hinge leaf; and
a hidden closure system affixed to said rotatable hinge leaf for engaging and releasing said latch hook.

2. The door hinge of claim 1, wherein said closure system further comprises a latch and release mechanism for engaging said latch hook during the door's final approach to enable the door to close softly.

3. The door hinge of claim 1, wherein said closure system is hidden within a member selected from the group consisting of door jam, door frame or door.

4. The door hinge of claim 1, wherein said closure system further comprises a closing mechanism having a cylinder body which confines a fluid and a plunger for compressing and expanding said fluid.

5. The door hinge of claim 4, wherein said fluid is selected from the group consisting hydraulic oil, nitric oxide, air or other compressible material.

6. The door hinge of claim 4, wherein said compressing and expanding of said fluid assists the door in opening and closing.

7. The door hinge of claim 4, wherein said closure system further comprises a locking mechanism for maintaining said fluid in a compressed state.

8. The door hinge of claim 4, wherein said closure system further comprises a locking mechanism for releasing said fluid from its compressed state.

9. The door hinge of claim 1, wherein said closure system further comprises a latch and release mechanism for releasing said latch hook to enable the door to swing freely.

10. An automatic door closing mechanism, comprising:
a hinge pin;
a stationary hinge leaf fixed to said hinge pin and adapted to be fixed to the door frame;
a rotatable hinge leaf rotatably mounted to said hinge pin and adapted to be fixed to the door;
a latch hook affixed to said stationary hinge leaf; and
means for engaging and releasing said latch hook affixed to said rotatable hinge leaf.

11. The automatic door closing mechanism of claim 10, wherein said means for engaging and releasing engages said latch hook during the door's final approach to enable the door to close softly.

12. The automatic door closing mechanism of claim 10, wherein said means for engaging and releasing releases said latch hook to enable the door to swing freely.

13. The automatic door closing mechanism of claim 10, wherein said means for engaging and releasing is hidden within a member selected from the group consisting of door jam, door frame or door.

14. The automatic door closing mechanism of claim 10, wherein said means for engaging and releasing further comprises a cylinder body which confines a fluid and a plunger for compressing and expanding said fluid.

15. The automatic door closing mechanism of claim 14, wherein said fluid is selected from the group consisting hydraulic oil, nitric oxide, air or other compressible material.

16. The automatic door closing mechanism of claim 14, wherein said compressing and expanding of said fluid assists the door in opening and closing.

17. The automatic door closing mechanism of claim 14, wherein said means for engaging and releasing further comprises a locking mechanism for maintaining said fluid in a compressed state.

18. The automatic door closing mechanism of claim 14, wherein said means for engaging and releasing further comprises a locking mechanism for releasing said fluid from its compressed state.

19. A method for an automatic door closing hinge with a hidden non-continuous latch and release closure system, comprising:
providing a hinge pin having a stationary hinge leaf fixed to said hinge pin and adapted to be fixed to the door frame, and a rotatable hinge leaf rotatably mounted to said hinge pin and adapted to be fixed to the door;
a latch hook affixed to said stationary hinge leaf;
a hidden closure system affixed to said rotatable hinge leaf;
engaging said latch hook during the door's final approach to ensure complete closure; and
releasing said latch hook to enable the door to swing freely and maintain an open position.
